(19) United States
(12) Patent Application Publication
(10) Pub. No.: US 2026/0016283 A1
(43) Pub. Date: Jan. 15, 2026

(54) METHOD FOR MEASURING TRIANGULAR PROFILE BASED ON BROAD SPECTRUM LIGHT SOURCE

(71) Applicants: Xiamen WeiYa Intelligent Technology Co., Ltd., Xiamen, Fujian (CN); Xiamen Leading Intelligent Generation Co., Ltd., Xiamen, Fujian (CN)

(72) Inventor: Haowei LIU, Xiamen, Fujian (CN)

(21) Appl. No.: 18/994,755

(22) PCT Filed: Feb. 6, 2024
(86) PCT No.: PCT/CN2024/076290

§ 371 Date: Jan. 15, 2025

(30) Foreign Application Priority Data
Jun. 16, 2023 (CN) 202310717630.X
Jun. 16, 2023 (CN) 202310717642.2

(51) Int. Cl. G01B 11/00; G01B 11/06; G01B 11/22

(52) U.S. Cl. CPC G01B 11/002; G01B 11/0608; G01B 11/22

(57) ABSTRACT

Disclosed is a method for measuring a triangular profile based on a broad spectrum light source, including the following steps: first, building a triangular laser measurement model; putting a calibrator in the triangular laser measurement model, measuring object plane coordinates (x, z) of the calibrator by virtue of a measuring instrument, moving the calibrator many times to acquire object plane coordinates of a plurality of groups of calibrators and corresponding image plane coordinates, so as to obtain a coefficient-determined relational expression of a two-variable linear function; and finally, putting a measured object in the triangular laser measurement model, acquiring, by an imaging detector, image plane coordinates (u, v) of a measured object plane, calculating a coordinate z of the measured object plane through the relational expression of the function, driving, by a displacement moving mechanism, the measured object to move relative to an optical axis of a focused light beam in a perpendicular direction to measure a coordinate y, and splicing an object plane profile (x, z) in a displacement distance to obtain a whole object plane profile of the measured object, so as to obtain a 3D size of the whole measured object. The present invention features a large tolerance angle, high compatibility, and a high measurement accuracy, and the volume and cost are greatly reduced.

### TECHNICAL FIELD

The present invention belongs to the technical field of light measurement and particularly relates to a method for measuring a triangular profile based on a broad spectrum light source.

### BACKGROUND

Laser triangulation measurement and spectral confocal imaging measurement are the commonest 3D optical measurement modes. In terms of consumption cost and efficiency, the laser triangulation measurement is even better. However, the laser triangulation measurement has a relatively high requirement on light source and uses collimated laser (narrow spectrum, with the spectral width less than 10 nm). The divergence angle of a beam is very small. Energy of reflected light changes quite sensitively with angle, which results in a problem of poor imaging of a specularly reflected object. In comparison, the spectral confocal imaging measurement is superior to the laser triangulation measurement, and uses a focused light beam rather than a non-collimated beam. Its angle compatibility and imaging quality are better. In addition, a receiving lens and a transmitting lens of a spectral confocal sensor are same, so that dispersion of the transmitting lens can be compensated. Then, a spectrum of the reflected light is analyzed with a spectrometer, so that a height of the reflected object is calculated, as shown in FIG. 1. However, a spectral confocal model uses a solution of dispersion confocal and spectral measurement, with a quite complex light path. Arrangement of the spectrometer further induces a relatively large size and a relatively high cost. The price of a common spectral confocal product is more than three times of that of triangular laser, so that the acquisition cost is increased.

A broad spectrum usually refers to a spectrum with the spectral width larger than 10 nm. Different from the narrow spectrum with the spectral width less than 10 nm, an acquisition condition of the broad spectrum is relatively easy. Therefore, to overcome the above defects, the present invention provides a triangular laser 3D measurement technology based on a broad spectrum.

### SUMMARY

An object of the present invention is to provide a method for measuring a triangular profile based on a broad spectrum light source and features a large tolerance angle, high compatibility, and a high measurement accuracy, and the volume and cost are greatly reduced.

To achieve the above object, the present invention adopts the following technical solution: a method for measuring a triangular profile based on a broad spectrum light source includes the following steps:
S1: building a model: arranging a triangular laser measurement model in a dispersion area, the model comprising the broad spectrum light source, a dispersion lens, a displacement moving mechanism, a measured object plane, a high resolution imaging lens, an imaging detector, and a data processing system, where the broad spectrum light source emits a divergent beam; the dispersion lens focuses colored light with different colors of the divergent beam at different heights of the measured object plane to form a focused light beam, the measured object plane reflects the focused light beam to the high resolution imaging lens at an angle, the displacement moving mechanism is configured to set a measured object to drive the measured object to move, a moving direction is perpendicular to an optical axis direction of the focused light beam, and the displacement moving mechanism is connected to the data processing system; the high resolution imaging lens focuses the reflected light beam to the imaging detector for imaging; and the imaging detector and the data processing system are configured to convert an optical signal into an electric signal and to generate data needed by 3D measurement;

S2: using a calibrator: first, putting the calibrator in place of the measured object in the triangular laser measurement model and setting a three-dimensional coordinate system, then measuring object plane coordinates (x, z) of the calibrator by virtue of a high precision measuring instrument, where the coordinate x represents a coordinate in a focused light beam direction and the coordinate z represents a vertical coordinate, and then acquiring image plane coordinates (u, v) in the imaging detector, where u is an element corresponding to the coordinate x and v is an element corresponding to the coordinate z;
establishing a mapping relation between the object plane coordinates and the image plane coordinates in the dispersion area by moving the calibrator to generate a “uv-xz comparison table” or a relational expression of a two-variable linear function for calculation:

$${x}_{0} = a u + bv + {δ}_{1} \qquad ( 1 )$$

$${z}_{0} = cu + dv + {δ}_{2} \qquad ( 2 )$$

where a, b, c, d, δ₁ and δ₂ all are coefficients;
moving the calibrators many times to acquire object plane coordinates and corresponding image plane coordinates of a plurality of groups of calibrators, to substitute the plurality of groups of object plane coordinates and image plane coordinates into the equations (1) and (2) to solve values of a, b, c, d, δ₁, and δ₂, so as to finally obtain the coefficient-determined relational expression of the two-variable linear function; and
S3: measuring 3D size data of the measured object: putting the measured object in the triangular laser measurement model, acquiring the image plane coordinates (u, v) of the measured object plane by the imaging detector, calculating coordinates x and y of each point of the measured object plane by inquiring the uv-xz comparison table or through the values u and v and the relational expression of the two-variable linear function, where n points form a line and n lines form a plane, to obtain a profile of the measured object plane; moreover, driving, by the displacement moving mechanism, the measured object to move relative to the optical axis of the focused light beam in the perpendicular direction, that is, supposing the moving direction as a y direction, segmenting, by the displacement moving mechanism, a plurality of sections of moving units in the y direction, thus recording the moving units of the profile of the measured object plane from appearance in the image plane coordinates to disappearance in the image plane coordinates; and finally, adding the recorded moving units to obtain a coordinate y of the measured object, and splicing the object plane profiles (x, y) in each moving unit to obtain a whole object plane profile of the measured object, to obtain a 3D size of the whole measured object, comprising coordinates x, y and z of any point on the measured object, so as to acquire a flaw depth or height on the measured object plane.

Further, the step S3 is replaced as follows: putting the measured object in the triangular laser measurement model, calculating coordinates x and y of each point of the measured object plane through the values u and v and the relational expression of the two-variable linear function, where n points form a line and n lines form a plane, to obtain a profile of the measured object plane; moreover, driving, by the displacement moving mechanism, the measured object to move relative to the optical axis of the focused light beam in the perpendicular direction, that is, supposing the moving direction as a y direction, arranging a stepping motor in the displacement moving mechanism, first setting a step pitch of the stepping motor, then recording the moving units of the profile of the measured object plane from appearance in the image plane coordinates to disappearance in the image plane coordinates; and finally, converting the pulse quantity into a displacement to obtain a coordinate y of the measured object, and similarly, splicing the object plane profiles (x, y) within the displacement distance to obtain a whole object plane profile of the measured object, to obtain a 3D size of the whole measured object, including coordinates x, y and z of any point on the measured object, so as to acquire a flaw depth or brightness on the measured object plane.

Further, the broad spectrum light source is a point spectrum, and the imaging detector is a linear array detector.

Further, the broad spectrum light source is a multi-point spectrum, and the imaging detector is a multi-linear array detector.

Further, the broad spectrum light source is a line light source, and the imaging detector is an area array detector.

Further, the dispersion lens performs dispersion processing on the light emitted by the broad spectrum light source, and the high resolution imaging lens is a common imaging lens without dispersion.

Further, the measured object plane is located between the dispersion lens and the high resolution imaging lens.

Further, the imaging detector and the data processing system are located on a focal plane of the high resolution imaging lens.

Further, in the step S2, a mapping relation between the object plane coordinates and the image plane coordinates in the dispersion area is established by moving the calibrator to generate a relational expression of a two-variable linear function for calculation;

in the step S3, the measured object is put in the triangular laser measurement model, the imaging detector acquires the image plane coordinates (u, v) of the measured object plane, and in the “ux-xz” comparison table, the object plane coordinates (x, z) of the corresponding point can be found through the values u and v, and the coordinates x and z of each point of the measured object plane are calculated by inquiring the “ux-xz” comparison table or by the relational expression of the two-variable linear function.

Further, the triangular laser measurement model is scanned to obtain a transversal line, a polyline or a surface profile and a multilayered structure of a target measured object.

By adopting the above-mentioned solution, the present invention has the following beneficial effects:

By virtue of the broad spectrum light source, the emitted light wave can be decomposed into different convergent beams and forms light with a convergent wavelength at different heights. The major wavelength of object reflection is the convergent wavelength. Therefore, the beam has a little change at different heights. A problem that the convergent beam is widened in a defocused state can be solved, so that a good measurement precision of the measurement model can be kept with a large height range.

In the prior art, a receiving lens and a transmitting lens of a spectral confocal sensor are same. Dispersion of the transmitting lens needed to be compensated, and then a spectrum of the reflected light is analyzed with a spectrometer, so that 3D size data of the reflected object is calculated. A receiving end in the present invention uses the triangular laser receiving lens without compensating the dispersion, can image directly and is free of the spectrometer, so that the light path is simplified. In addition, the overall structure of the system is simpler, and the volume and cost can be greatly reduced, so that a more superior measurement precision can be achieved. The dispersion lens provided in the present invention can focus light with different wavelengths of the broad spectrum light source to different height of an object plane. With respect to the focused light beam, the reflected light has a certain divergence angle, so that the tolerability of the model to the degree of inclination of the surface of the object is improved, and the measurement precision is also improved. Therefore, the model provided by the present invention can measure specularly reflected objects such as a metal and glass, and also can measure objects with radians or steps on the surfaces such as 3D glass, grooves and weld joints.

Compared with the prior art, the present invention also has the advantages that
the broad spectrum beam has the certain divergence angle. Therefore, even a detected target surface is specularly reflected. The reflected beam has the certain divergence angle, so that the angular sensitivity of the measurement model is reduced, and the capacity of the model to detect the specularly reflected target is improved. For a diffuse reflection target, this broad spectrum lighting mode still has an advantage of improving the capacity of the measurement mode to detect bended and inclined surfaces. Compared with a linear laser system, the system features a relatively large tolerance angle and a relatively high measurement precision. Compared with the spectral confocal system, the volume and cost of the system can be greatly reduced. Therefore, a broad spectral beam system not only can overcome defects of a linear laser system and a spectral confocal system, but also can combine advantages of the two, so that the application scenarios and range of the measurement system can be effectively expanded.

### BRIEF DESCRIPTION OF DRAWINGS

FIG. 1 is a schematic diagram of an existing spectral confocal model;

FIG. 2 is a schematic structural diagram I of a laser triangulation measurement model based on a broad spectrum light source in an embodiment;

FIG. 3 is a schematic structural diagram I (imaging change) of a laser triangulation measurement model based on a broad spectrum light source in the embodiment;

FIG. 4 is a schematic diagram of a laser triangulation measurement model based on a broad spectrum light source in an embodiment; and

FIG. 5 is a schematic diagram of an imaging relationship between image plane coordinates and an object plane coordinates of the present invention.

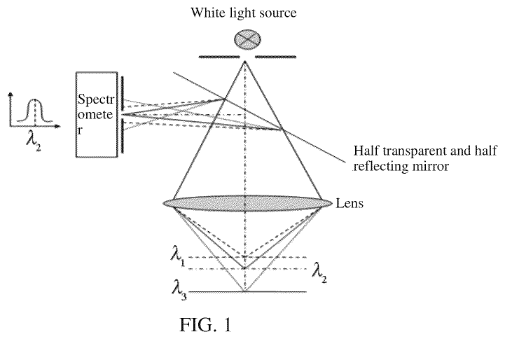

Description of numerals: 1—spectrum light source; 2—dispersion lens; 3—measured object plane; 4—high resolution imaging lens; 5—imaging detector; 6—displacement moving mechanism.

### DESCRIPTION OF EMBODIMENTS

Embodiments of the present invention will be described below more completely. The present invention may have various embodiments, and adjustments and changes may be made in the embodiments. However, it shall be understood that it is not intended to limit the protection of the present invention in specific embodiments of the disclosure and the present invention shall be understood to cover all adjustments, equivalents and/or optional solutions falling within the spirit and scope of various embodiments of the present invention.

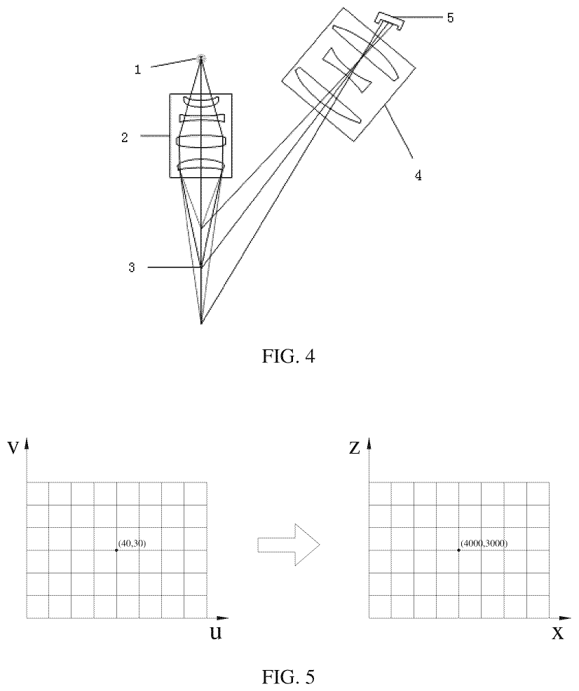

The present invention relates to a laser triangulation measurement model based on a broad spectrum light source, as shown in FIG. 4, including a broad spectrum light source 1, a dispersion lens 2, a measured object plane 3, a high resolution imaging lens 4, an imaging detector 5 and a data processing system, and a displacement moving mechanism 6.

The broad spectrum light source 1 transmits a divergent beam, the broad spectrum light source 1 is located in front of the dispersion lens 2, and the dispersion lens 2 disperses light of the broad spectrum light source 1;

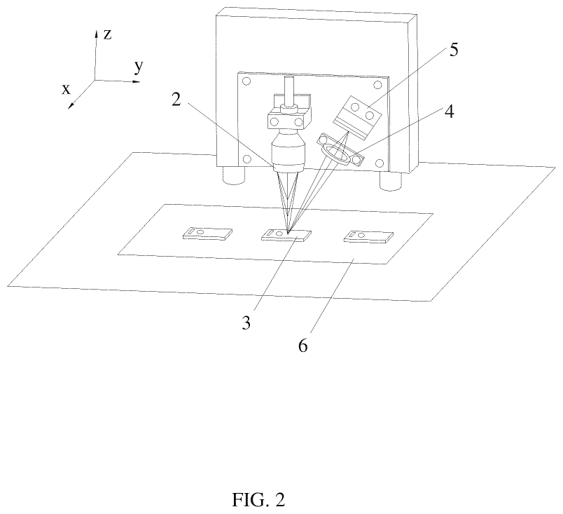

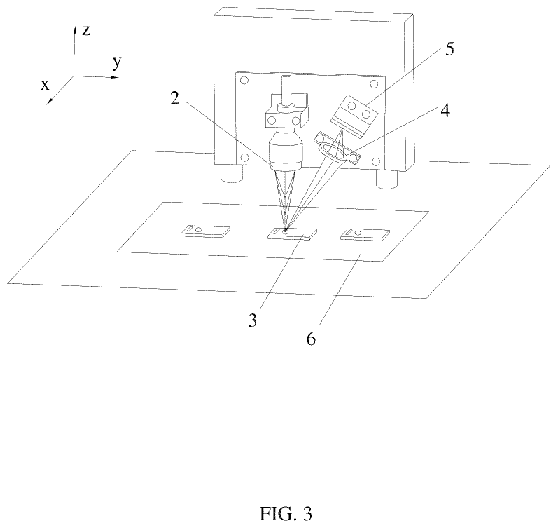

The dispersion lens 2 focuses colored light with different colors of the divergent beam to different heights of the measured object plane 3 to form a focused light beam. The displacement moving mechanism 6 is configured to place the measured object to drive the measured object to move, where a moving direction is perpendicular to an optical axis direction of the focused light beam. The measured object plane is located between the dispersion lens and the high resolution imaging lens, the measured object plane 3 reflects the focused light beam to the high resolution imaging lens 4, the high resolution imaging lens 4 focuses the reflected beam to the imaging detector 5 to image, and the imaging detector and the data processing system are located on a focal plane of the high resolution imaging lens. When there are flaws such as depressions on the measured object plane shown in FIG. 2 and FIG. 3, the reflected beam changes, so that the image on the imaging detector 5 changes as well. The imaging detector 5 converts a light signal into an electric signal and transmits the electric signal to the data processing system. The data processing system generates data needed by 3D measurement. The displacement moving mechanism 6 is connected to the data processing system. In the solution, the displacement moving mechanism 6 can be mechanisms such as a conveyor belt and a transport disc capable of generating a displacement movement.

The present invention relates to a method for measuring a triangular profile based on a broad spectrum light source. The data processing system can realize 3D measurement by the following measurement methods, specifically including the following steps:
S1: building a model: arranging a triangular laser measurement model in a dispersion area;
S2: using a calibrator: first, putting the calibrator replacing the measured object in the triangular laser measurement model and setting a three-dimensional coordinate system, then measuring object plane coordinates (x, z) of the calibrator by virtue of a high precision measuring instrument (an infrared laser range finder, an interferometer and the like), where the coordinate x represents a coordinate in a focused light beam direction and the coordinate z represents a vertical coordinate, and then acquiring image plane coordinates (u, v) of the imaging detector, where u is an element corresponding to the coordinate x and v is an element corresponding to the coordinate z;
establishing a complete relation between the object plane coordinates and the image plane coordinates in the dispersion area by moving the calibrator to generate “uv-xz comparison table” or a relational expression of a two-variable linear function for calculation:

$${x}_{0} = a u + bv + {δ}_{1} \qquad ( 1 )$$

$${z}_{0} = cu + dv + {δ}_{2} \qquad ( 2 )$$

where a, b, c, d, δ₁ and δ₂ all are coefficients;
moving the calibrators many times to acquire object plane coordinates and corresponding image plane coordinates of the plurality of groups of calibrators, to substitute a plurality of object plane coordinates and image plane coordinates into the equations (1) and (2) to solve values of a, b, c, d, δ₁, and δ₂, so as to finally obtain the coefficient-determined relational expression of the two-variable linear function, where the large the class number is, the more accurate the fitting is;
S3: measuring 3D size data of the measured object: putting the measured object in the triangular laser measurement model, acquiring the image plane coordinates (u, v) of the measured object plane by the imaging detector, calculating coordinates x and y of each point of the measured object plane by inquiring the “ux-xz comparison table” or through the relational expression of the two-variable linear function: superficially, 1, in the “ux-xz comparison table”, seeking for the object plane coordinates (x, y) of the corresponding point through the u and v values, where the depth or height can be measured regardless of a convex surface or a concave surface if the height of each point is known; and 2, detecting object plane coordinates (x, z) corresponding to each point on the measured object, where, for example, as shown in FIG. 5, values u and v of point coordinates (40, 30) of an image plane coordinate system on the left side are respectively 40 and 30, and x and z of the object plane coordinate system mapped to the right side calculated by the two-variable linear function are respectively 4000 and 3000, that is, the point coordinates of the object plane coordinates are (4000, 3000); therefore, n points form a line and n lines form a plane, to obtain a profile of the measured object plane; moreover, driving, by the displacement moving mechanism, the measured object to move relative to the optical axis of the focused light beam in the perpendicular direction, that is, supposing the moving direction as a y direction, segmenting, by the displacement moving mechanism, a plurality of sections of moving units in the y direction, where the large the number of segments of the arranged moving units is, the more accurate the data is, thus recording the moving units of the profile of the measured object plane from appearance in the image plane coordinates to disappearance in the image plane coordinates; and finally, adding the recorded moving units to obtain a coordinate y of the measured object, and splicing the object plane profiles (x, y) in each moving unit to obtain a whole object plane profile of the measured object, to obtain a 3D size of the whole measured object, including coordinates x, y and z of any point on the measured object, so as to acquire a flaw depth or height on the measured object plane, where the higher the density of the moving units is, the fine the 3D size is and the higher the measured flaw precision is;
or, arranging a stepping motor in the displacement moving mechanism, first setting a step pitch of the stepping motor, then recording a pulsed quantity of the measured object from appearance of the object plane profile in the image plane coordinates to disappearance in the image plane coordinates; and finally, converting the pulse quantity into a displacement to obtain the coordinate y of the measured object, and similarly, splicing the object plane profiles (x, y) within the displacement distance to obtain a whole object plane profile of the measured object, to obtain the 3D size of the whole measured object, including coordinates x, y and z of any point on the measured object, so as to acquire a flaw depth or brightness on the measured object plane.

The calibrator can be an object in any shape, for example, a calibration block, a calibration board and the like.

The broad spectrum light source provided by the present invention can be a single-point spectrum, so that a single-point measurement mode is obtained; can be a multipoint spectrum, so that a multipoint measurement model is obtained; and can also be a linear light source, so that a linear measurement mode is obtained; and correspondingly, the imaging detector can be either a linear array detector or a multi-linear array detector or an area array detector. The triangular laser measurement model is scanned to obtain a transversal line, a polyline or a surface profile and a multilayered structure of a target measured object.

The dispersion lens provided in the present invention can focus light with different wavelengths of the broad spectrum light source to different height of an object plane. With respect to the focused light beam, the reflected light has a certain divergence angle, so that the tolerability of the model to the degree of inclination of the surface of the object is improved, and the measurement precision is also improved. Therefore, the model provided by the present invention can measure specularly reflected objects such as a metal and glass, and also can measure objects with radians or steps on the surfaces such as 3D glass, grooves and weld joints.

The high resolution imaging lens provided by the present invention is a common imaging lens that corrects the chromatic aberration and performs measurement dependent on measurement of the height of the focused light beam rather than color. Without the need to differentiate the colors, a subsequent spectrum measurement mode is omitted, so that a relatively large cost and space are saved. Just because of this, the model has a higher precision than a common laser triangulation measurement model, and has more excellent cost performance than the spectral confocal model.

The imaging detector and the data processing system provided by the present invention include the imaging detector and the data processing system. According to different light sources, the imaging detector can be a single-linear, multi-linear or area array, so as to form a single-point, multi-point or liner measurement model. The data processing system converts signals detected by the imaging detector into data information and stores the data information, and has high speed signal processing and transmission functions.

Because the light transmitted by the broad spectrum light source is the focused light beam dispersed by the dispersion lens, light with different wavelengths is focused at different height, and therefore, there will be focused wavelength at each height, and the major wavelength reflected by the object is the focused wavelength. Because the beams with different wavelengths are convergent, the width of the beam changes a little at different heights. A problem that the convergent beam is widened in a defocused state can be solved, so that a better measurement precision of the system can be kept with a large height range. The receiving end uses a triangular laser receiving lens rather than a spectral measurement mode. Such a system is relatively simple in structure, and the volume and cost can be greatly reduced. Such a structure combines advantages of spectral confocal measurement and laser triangulation measurement and overcomes shortcomings of the two, so that the application scenarios and scope of the measurement system are expanded.

The method for measuring a triangular profile based on a broad spectrum light source provided by the embodiment of the patent is introduced in detail. Particular examples are used herein to explain the principle and embodiments of the patent, and the above description of the embodiments is only used to help understanding the methods and core concept of the patent. Moreover, alternations will be made by those of ordinary skill in the art on the specific embodiments and application range in accordance with the thought of the patent. In conclusion, the content of the description shall not be construed as limitation to the patent.

1. A method for measuring a triangular profile based on a broad spectrum light source, comprising the following steps:
S1: building a model, comprising: arranging a triangular laser measurement model in a dispersion area, the model comprising the broad spectrum light source, a dispersion lens, a displacement moving mechanism, a measured object plane, a high resolution imaging lens, an imaging detector, and a data processing system, wherein the broad spectrum light source emits a divergent beam, the dispersion lens focuses colored light with different colors of the divergent beam at different heights of the measured object plane to form a focused light beam, the measured object plane reflects the focused light beam to the high resolution imaging lens at an angle to yield a reflected light beam, the displacement moving mechanism is configured to set a measured object to drive the measured object to move, a moving direction is perpendicular to an optical axis direction of the focused light beam, the displacement moving mechanism is connected to the data processing system, the high resolution imaging lens focuses the reflected light beam to the imaging detector for imaging, and the imaging detector and the data processing system are configured to convert an optical signal into an electric signal and to generate data needed by three-dimensional (3D) measurement;
S2: using a calibrator, comprising: first, putting the calibrator in place of the measured object in the triangular laser measurement model and setting a three-dimensional coordinate system, then measuring object plane coordinates (x, z) of the calibrator by virtue of a measuring instrument, where the measuring object plane coordinate x represents a coordinate in a focused light beam direction and the measuring object plane coordinate z represents a vertical coordinate, and then acquiring image plane coordinates (u, v) in the imaging detector, where image plane coordinate u is an element corresponding to the measuring object plane coordinate x and image plane coordinate v is an element corresponding to the measuring object plane coordinate z;
establishing a mapping relation between the object plane coordinates and the image plane coordinates in the dispersion area by moving the calibrator to generate a “uv-xz comparison table” or a relational expression of a two-variable linear function for calculation:
$${x}_{0} = a u + bv + {δ}_{1} \qquad ( 1 )$$
$${z}_{0} = cu + dv + {δ}_{2} \qquad ( 2 )$$
where a, b, c, d, δ₁ and δ₂ all are coefficients;
moving the calibrator a plurality of times to acquire object plane coordinates and corresponding image plane coordinates of a plurality of groups of the calibrator, to substitute the object plane coordinates and image plane coordinates into the equations (1) and (2) to solve values of a, b, c, d, δ₁, and δ₂, so as to finally obtain a coefficient-determined relational expression of the two-variable linear function; and
S3: measuring 3D size data of the measured object, comprising: putting the measured object in the triangular laser measurement model, acquiring the image plane coordinates (u, v) of the measured object plane by the imaging detector, calculating measuring object plane coordinate x and the measuring object plane coordinate y of each point of the measured object plane by inquiring to a “ux-xz comparison table” or through the image plane coordinate u and the image plane coordinate v and the relational expression of the two-variable linear function, in the “ux-xz comparison table”, seeking the object plane coordinates (x, y) of a corresponding point through the image plane coordinate u and the image plane coordinate v, where a depth or a height is configured to be measured regardless of a convex surface or a concave surface when the height of each point is known, wherein n points form a line and n lines form a plane, to obtain a profile of the measured object plane; moreover, driving, by the displacement moving mechanism, the measured object to move relative to an optical axis of the focused light beam in a perpendicular direction by segmenting, by the displacement moving mechanism, a plurality of sections of moving units in the moving direction, thus recording the moving units of the profile of the measured object plane from appearance in the image plane coordinates to disappearance in the image plane coordinates; and finally, adding the moving units to obtain the measuring object plane coordinate y of the measured object, and splicing object plane profiles (x, y) in each moving unit to obtain a whole object plane profile of the measured object, to obtain a 3D size of entirety of the measured object, comprising coordinates x, y and z of any point on the measured object, so as to acquire a flaw depth or height on the measured object plane.

2. (canceled)

3. The method for measuring a triangular profile based on a broad spectrum light source according to claim 1, wherein the broad spectrum light source is a point spectrum, and the imaging detector is a linear array detector.

4. The method for measuring a triangular profile based on a broad spectrum light source according to claim 1, wherein the broad spectrum light source is a multi-point spectrum, and the imaging detector is a multi-linear array detector.

5. The method for measuring a triangular profile based on a broad spectrum light source according to claim 1, wherein the broad spectrum light source is a line light source, and the imaging detector is an area array detector.

6. The method for measuring a triangular profile based on a broad spectrum light source according to claim 1, wherein the dispersion lens performs dispersion processing on the light emitted by the broad spectrum light source, and the high resolution imaging lens is a common imaging lens without dispersion.

7. The method for measuring a triangular profile based on a broad spectrum light source according to claim 1, wherein the measured object plane is located between the dispersion lens and the high resolution imaging lens.

8. The method for measuring a triangular profile based on a broad spectrum light source according to claim 1, wherein the imaging detector and the data processing system are located on a focal plane of the high resolution imaging lens.

9. (canceled)

10. The method for measuring a triangular profile based on a broad spectrum light source according to claim 1, wherein the triangular laser measurement model is scanned to obtain a transversal line, a polyline or a surface profile and a multilayered structure of a target measured object.
